(19) United States
(12) Patent Application Publication
(10) Pub. No.: US 2026/0319336 A1
(43) Pub. Date: Oct. 15, 2026

(54) Driving Arrangement, Camera Module and Electronic Device

(71) Applicant: NINGBO SUNNY OPOTECH CO., LTD, Yuyao City (CN)

(72) Inventors: Chao Li, Yuyao City (CN); Kaidi Cen, Yuyao City (CN); Pengfei Zhou, Yuyao City (CN); Chen Hsien Fan, Yuyao City (CN); Yinli Fang, Yuyao City (CN); Rong Hu, Yuyao City (CN)

(21) Appl. No.: 19/372,354

(22) Filed: Oct. 29, 2025

(30) Foreign Application Priority Data
Apr. 14, 2025 (CN) 2025104582550

(51) Int. Cl. G03B 13/36; G02B 7/09; H04N 23/54

(52) U.S. Cl. CPC G03B 13/36; G02B 7/09; H04N 23/54

(57) ABSTRACT

A driving arrangement for camera module includes a base, a support assembly, a carrier, and a driving assembly, wherein the carrier is supported on the base by the support assembly, and the driving assembly includes a first driving part and a second driving part arranged on opposite sides of the carrier, wherein the first driving part includes a first magnet and a first coil arranged oppositely; the second driving part includes a second magnet and a second coil arranged oppositely, wherein the magnetic pole distribution of the first magnet facing the first coil is the same as or different from the magnetic pole distribution of the second magnet facing the second coil along the optical axis direction.

### CROSS REFERENCE OF RELATED APPLICATION

This application is a non-provisional application that claims priority under 35U.S.C. §119 to China application number CN201510458255.0, filing date Apr. 14, 2025, wherein the entire content of which is expressly incorporated herein by reference.

### BACKGROUND OF THE PRESENT INVENTION

### FIELD OF INVENTION

The present invention relates to the field of camera technology, and more particularly to a driving arrangement, a camera module and an electronic device.

### DESCRIPTION OF RELATED ARTS

With the popularity of mobile electronic devices, technologies related to camera modules used in such devices to assist users in capturing images have developed and advanced rapidly. In the market, consumers are demanding increasingly diverse and high-level functionalities from camera modules configured in mobile electronic devices (e.g., smartphones).

Currently, the common optical focus function is mainly achieved by setting a driving arrangement in the camera module to drive the optical lens to move along the optical axis. When the conventional driving arrangement realizes the optical focus function, it often increases the size of the driving arrangement, which is contrary to the development trend of mobile devices to be thinner and lighter.

As consumer demands increase, the requirements for driving arrangements also increase. For example, the lateral dimensions of the driving arrangement are required to be reduced. Therefore, how to further reduce the size of the driving arrangement while meeting high performance has become an important direction for current technological development.

### SUMMARY OF THE PRESENT INVENTION

An object of the present application is to provide an optical focus driving arrangement and a camera module with a smaller size.

Another object of the present application is that the driving arrangement of the present application can be applied to the front camera module of a mobile phone, so that the front camera module has an optical focus function while avoiding a significant increase in size.

In order to achieve the above objects, the technical solution adopted in the present application is a driving arrangement, comprising:
a base;
a support assembly;
a carrier, wherein the carrier has an optical through-hole penetrating along an optical axis direction, the carrier has a first corner and a second corner at a diagonal position, and the carrier is supported on the base by the support assembly at the first corner and the second corner; and
a driving assembly arranged for driving the carrier to move along the optical axis direction with respect to the base, the driving assembly comprises a first driving part and a second driving part arranged on opposite sides of the carrier, wherein the first driving part comprises a first magnet and a first coil arranged oppositely, the first magnet is arranged on one of the carrier and the base, and the first coil is arranged on the other of the carrier and the base; wherein the second driving part comprises a second magnet and a second coil arranged oppositely, the second magnet is arranged on one of the carrier and the base, and the second coil is arranged on the other of the carrier and the base;
wherein along the optical axis direction, a magnetic pole distribution of the first magnet facing the first coil is the same as a magnetic pole distribution of the second magnet facing the second coil, and when the driving assembly is in operation, current directions in the first coil and the second coil are opposite when observed along a direction perpendicular to the optical axis direction;
or,
wherein along the optical axis direction, the magnetic pole distribution of the first magnet facing the first coil is opposite to the magnetic pole distribution of the second magnet facing the second coil, when the driving assembly is in operation, the current directions in the first coil and the second coil are the same when observed in the direction perpendicular to the optical axis direction.

As a preferred embodiment, the carrier further comprises a first side surface and a second side surface located on two sides of the first corner, and a third side surface and a fourth side surface located on two sides of the second corner, the first side surface is adjacent to the fourth side surface, the second side surface is adjacent to the third side surface, the first driving part is arranged on the first side surface, the second driving part is arranged on the third side surface, the first side surface and the third side surface are parallel to a second direction, the second side surface and the fourth side surface are parallel to a first direction, the first direction and the second direction are perpendicular to each other and are both perpendicular to the optical axis, and along the second direction, the first driving part and the second driving part are staggered.

As a preferred embodiment, the support assembly comprises a first guide member and a second guide member which are arranged on the base and extended along the optical axis direction, the first guide member is located at the first corner, the second guide member is located at the second corner, a central axis of the first guide member along the optical axis direction and a central axis of the second guide member along the optical axis direction define a support surface, the support surface has a central axis along the optical axis direction, the central axis of the support surface is at an equal vertical distance from the first guide member and the second guide member, and the first driving part and the second driving part are respectively located on two sides of the central axis of the support surface along the second direction.

As a preferred embodiment, the support assembly further comprises a first magnetic member arranged at the first corner and a second magnetic member arranged at the second corner, the first guide member is arranged opposite to the first magnetic member, and the second guide member is arranged opposite to the second magnetic member.

As a preferred embodiment, at least two contact positions between the first guide member and the carrier are arranged at intervals along the optical axis direction, at least one contact position is arranged between the second guide member and the carrier, a first magnetic attraction force is generated between the first magnetic member and the first guide member, a second magnetic attraction force is generated between the second magnetic member and the second guide member, and a size of the first magnetic member is larger than a size of the second magnetic member, so as to allow the first magnetic attraction force to be greater than the second magnetic attraction force.

As a preferred embodiment, on a plane perpendicular to the optical axis, an angle between a line connecting geometric centers of the second guide member and the second magnetic member and a line connecting geometric centers of the second guide member and the first guide member is α, and α≤90°.

As a preferred embodiment, the first magnetic member is disposed adjacent to the second side surface of the carrier, and the second magnetic member is disposed adjacent to the third side surface of the carrier.

As a preferred embodiment, a first avoidance hole is formed at a position where the second side surface of the carrier faces the first magnetic member, and a second avoidance hole is formed at a position where the third side surface of the carrier faces the second magnetic member, the base comprises a side wall arranged around an outer side of the carrier, and a first avoidance opening is formed at a position where the side wall of the base is corresponding to the first avoidance hole on the second side surface of the carrier, a size of the first avoidance opening is larger than a size of the first avoidance hole, and a portion of the second side surface of the carrier corresponding to the first avoidance opening protrudes outward to extend into the first avoidance opening.

As a preferred embodiment, the base further comprises an electric conductive part which is arranged around the side wall of the base, and a second avoidance opening is formed at a position where the electric conductive part is corresponding to the first avoidance opening.

As a preferred embodiment, the first magnetic member is arranged on the first side surface of the carrier, the second magnetic member is arranged on the third side surface of the carrier, a position sensing magnet is arranged on the second side surface of the carrier, a position sensor is arranged on the base opposite to the position sensing magnet, and a vertical distance between the center axis of the optical through-hole and the fourth side surface is smaller than a vertical distance between the center axis of the optical through-hole and the second side surface.

As a preferred embodiment, the carrier has a first contact surface and a second contact surface that are not coplanar at the first corner, the first guide member contacts the first contact surface and the second contact surface, the carrier has a third contact surface at the second corner, and the second guide member contacts the third contact surface; the central axis of the first guide member along the optical axis direction and the central axis of the second guide member along the optical axis direction define the support surface, the third contact surface is parallel to the support surface, an angle between the first contact surface and the support surface is θ1, an angle between the second contact surface and the support surface is θ2, θ1≠90°, θ2≠90°.

As a preferred embodiment, the first guide member contacts the carrier only at the first contact surface and the second contact surface, two contact positions are provided between the first guide member and the first contact surface and are spaced apart along the optical axis direction, two contact positions are provided between the first guide member and the second contact surface and are spaced apart along the optical axis direction, the second guide member contacts the carrier only at the third contact surface, and one contact position is provided between the second guide member and the third contact surface, wherein θ1=θ2.

As a preferred embodiment, a surface of the second magnetic member facing the second guide member is parallel to the third contact surface; and an angle between a surface of the first magnetic member facing the first guide member and the first contact surface and an angle between the surface of the first magnetic member facing the first guide member and the second contact surface are all acute angles.

As a preferred embodiment, a surface of the first magnetic member facing the first guiding member and a surface of the second magnetic member facing the second guiding member are respectively parallel to the support surface.

As a preferred embodiment, the present invention provides a camera module comprising:
an optical lens;
a photosensitive assembly arranged corresponding to the optical lens along the optical axis direction for receiving the light emitted by the optical lens for imaging, so as to obtain an image of the object; and
the driving arrangements described above, the optical lens is held on the photosensitive path of the photosensitive assembly by the driving arrangement, and the driving arrangement is suitable for driving the optical lens to move along the optical axis direction to achieve optical performance adjustment.

As a preference, the present invention provides an electronic device comprising the camera module as described above.

Compared with the prior art, the beneficial effects of this application are as follows.
(1) By optimizing the magnetic field distribution and current direction, the component force that is unfavorable to the driving carrier generated during the operation of the driving arrangement can be reduced, thereby reducing the risk of separation of the carrier with respect to the base and improving the stability of the camera module during active calibration.
(2) By optimizing the magnetic field distribution and current direction, a stronger driving force can be generated in a limited space without increasing the size of the magnet or coil, thereby reducing the overall size of the camera module.
(3) By optimizing the magnetic field distribution and current direction, energy loss can be reduced, energy conversion efficiency can be improved, and energy consumption can be reduced.

### BRIEF DESCRIPTION OF THE DRAWINGS

FIG. 1A is a perspective view of a camera module according to an embodiment of the present application.

FIG. 1B is an exploded view of a camera module according to an embodiment of the present application.

FIG. 1C is a sectional view of a camera module according to an embodiment of the present application.

FIG. 2A is a perspective view of a driving arrangement according to an embodiment of the present application.

FIG. 2B is a schematic view of the contact position between the guide member and the carrier of a driving arrangement according to an embodiment of the present application.

FIG. 3 is a schematic view of the structure of an internal support assembly and a driving assembly of a driving arrangement according to an embodiment of the present application.

FIG. 4 is a schematic view of the structure of an internal carrier of a driving arrangement according to an embodiment of the present application.

FIG. 5 is a schematic view of a force analysis of an internal carrier of a driving arrangement according to an embodiment of the present application.

FIG. 6 is a schematic view of the current direction of an internal coil of a driving arrangement according to an embodiment of the present application.

FIG. 7 is a schematic view of the current direction of an internal coil of a driving arrangement according to another embodiment of the present application.

FIG. 8 is a schematic view of the force component of an internal carrier of a driving arrangement according to an embodiment of the present application.

FIG. 9 is a schematic view of the force component of an internal carrier of a driving arrangement according to another embodiment of the present application.

FIG. 10 is a schematic view of the position of an internal driving assembly of a driving arrangement according to an embodiment of the present application.

FIG. 11 is a schematic view of the position of guide parts of a driving arrangement according to an embodiment of the present application.

FIG. 12 is a schematic view of the magnetic attraction effect between guide members of a driving arrangement according to an embodiment of the present application.

FIG. 13 is a schematic view of the magnetic attraction effect between guide members of a driving arrangement according to an embodiment of the present application.

FIG. 14 is a schematic view of the position setting of the second magnetic member of a driving arrangement according to an embodiment of the present application.

FIG. 15 is a schematic view of the position of an optical lens according to an embodiment of the present application.

FIG. 16 is a schematic view of the structure at the first corner A of a driving arrangement according to an embodiment of the present application.

FIG. 17 is a schematic view illustrating the position of a fixing insert of a driving arrangement according to an embodiment of the present application.

FIG. 18 is a schematic view illustrating the position of a position sensor, a position sensing magnet and an electric conduction portion of a driving arrangement according to an embodiment of the present application.

In the drawings: 1, optical lens; 11, lens barrel; 12, optical lens; 2, photosensitive assembly; 21, photosensitive chip; 22, optical filter element; 23, bracket; 24, imaging circuit board; 25, electronic component; 3, driving arrangement; 31, upper cover; 32, base; 321, side wall; 3211, first avoidance opening; 33, carrier; 331, first side surface; 332, second side surface; 3321, portion of the second side surface; 333, third side surface; 334, fourth side surface; 335, optical through-hole; 336, first guide part; 3361, first protrusion; 3362, second protrusion; 337, second guide part; 3371, third protrusion; 338, first avoidance hole; 339, second avoidance hole; 34, drive assembly; 341, first driving part; 3411, first magnet; 3412, first coil; 342, second driving part; 3421, second magnet; 3422, second coil; 35, support assembly; 351, first magnetic member; 3511, surface; 352, second magnetic member; 3521, surface; 353, first guide member; 3531, first support position; 3532, second support position; 3533, 3533a, 3533b, 3534, 3534a, 3534b, contact position; 354, second guide member; 3541, third support position; 3542, contact position; 355, support surface; 36, fixing insert; 37, position sensor; 38, position sensing magnet; 39, electric conductive part; 391, second avoidance opening; 392, electrical conduction portion; 41, first contact surface; 42, second contact surface; 43, third contact surface.

### DETAILED DESCRIPTION OF THE PREFERRED EMBODIMENT

Below, the present application is further described in conjunction with specific implementation methods. It should be noted that, under the premise of no conflict, the various embodiments or technical features described below can be arbitrarily combined to form new embodiments.

In the description of the present application, it should be noted that directional words, such as the terms "center", "lateral", "longitudinal", "length", "width", "thickness", "up", "down", "front", "back", "left", "right", "vertical", "horizontal", "top", "bottom", "inside", "outside", "clockwise", "counterclockwise", etc., indicating directions and positional relationships are based on the directions or positional relationships shown in the accompanying drawings, and are only for the convenience of narrating the present application and simplifying the description, and do not indicate or imply that the device or element referred to must have a specific direction, be constructed and operated in a specific direction, and cannot be understood as limiting the specific scope of protection of the present application.

It should be noted that the terms "first", "second", etc. in the description and claims of the present application are used to distinguish similar objects, and are not necessarily used to describe a specific order or sequence.

The terms "including" and "having" and any variations thereof in the specification and claims of this application are intended to cover non-exclusive inclusions. For example, a process, method, system, product or apparatus comprising a series of steps or units is not necessarily limited to those steps or units explicitly listed, but may comprise other steps or units not explicitly listed or inherent to these processes, methods, products or apparatuses.

In the drawings of the present application, the X, Y, and Z axes are coordinate axes of a spatial rectangular coordinate system, the first direction mentioned below in the present application is parallel to the X axis, the second direction is parallel to the Y axis, and the third direction and the optical axis are parallel to the Z axis. It should be understood that the optical axis direction of a driving arrangement 3 is the optical axis direction of an optical lens 1.

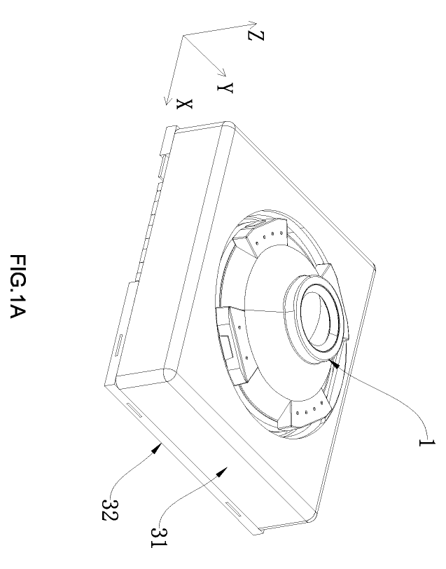

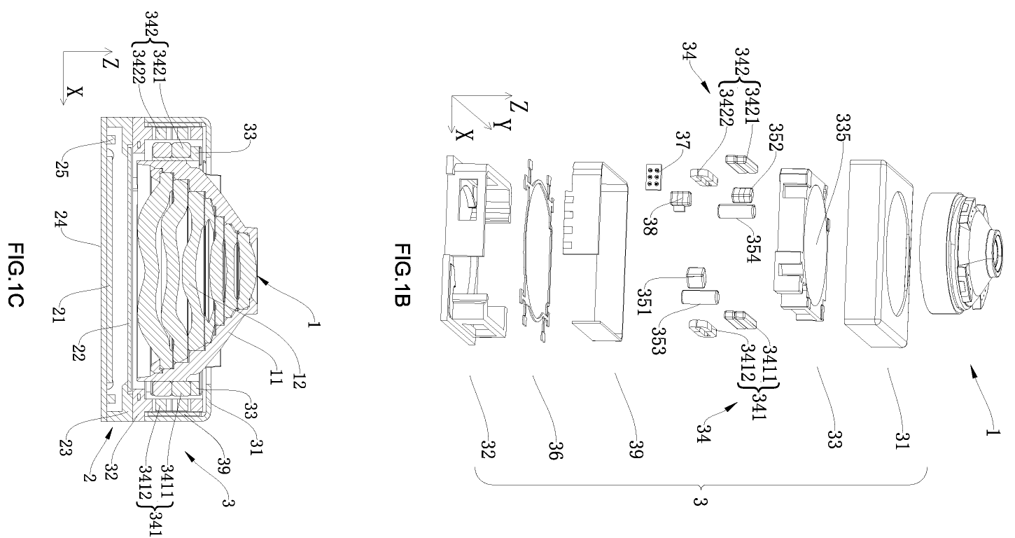

As shown in FIGS. 1A to 1C, an embodiment of the present application provides a driving arrangement 3 of a camera module, the driving arrangement 3 comprises a base 32, a carrier 33 movably disposed on the base 32, and a driving assembly 34 for driving the carrier 33 to move with respect to the base 32, the carrier 33 has an optical through-hole 335, an optical lens 1 is installed in the optical through-hole 335 of the carrier 33, and the driving assembly 34 is used to drive the carrier 33 to move with respect to the base 32 along the optical axis direction of the optical lens 1 to achieve an optical focusing function. A photosensitive assembly 2 of the camera module can be installed on the base 32, and the light is suitable for incident on the photosensitive assembly 2 for imaging after being converged by the optical lens 1.

In this embodiment, the driving arrangement 3 further comprises an upper cover 31 which is adapted to be mutually buckled with the base 32 to form a receiving cavity with the base 32 to protect other components of the driving arrangement 3.

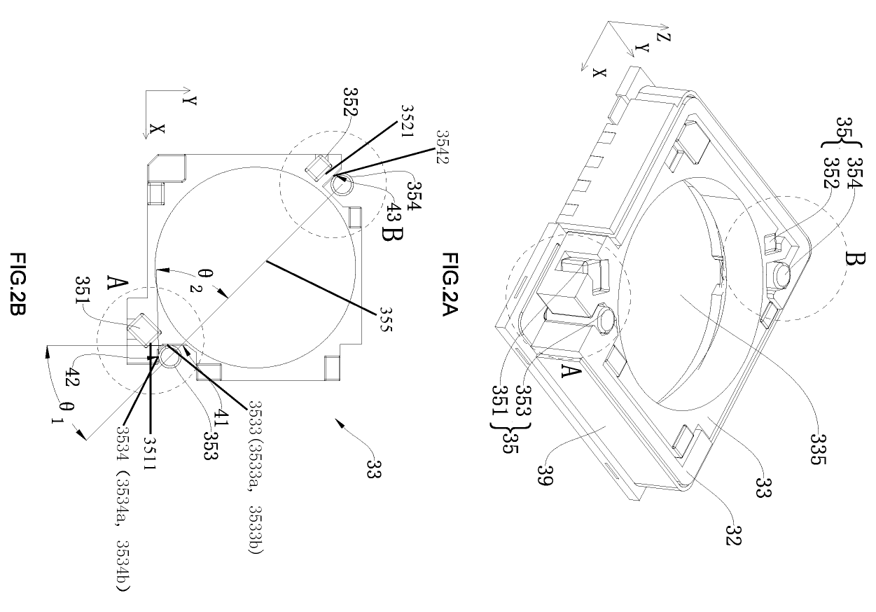

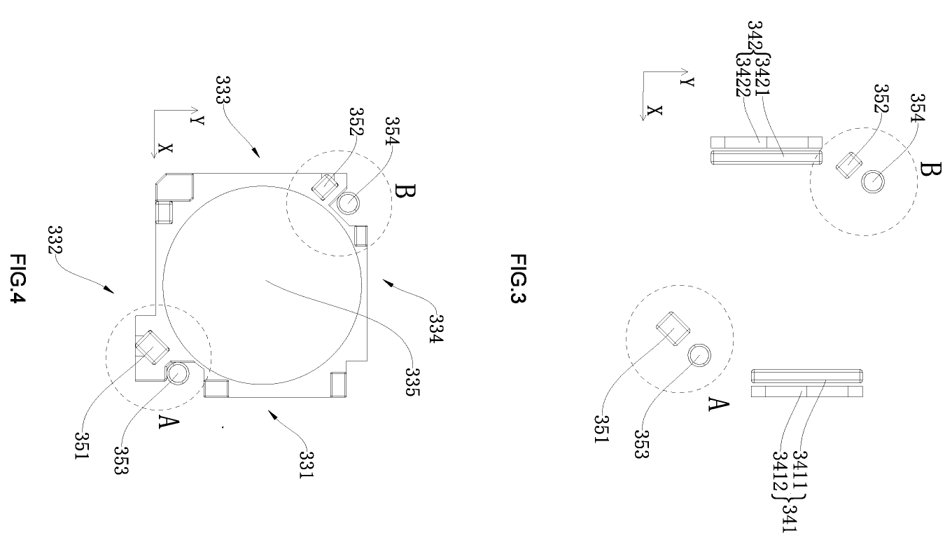

Furthermore, as shown in FIGS. 2A, 2B and 3, the driving arrangement 3 further comprises a support assembly 35, the carrier 33 has a first corner A and a second corner B at diagonal positions, and the carrier 33 is supported on the base 32 by the support assembly 35 at the first corner A and the second corner B.

In addition, the support assembly 35 comprises a first magnetic member 351 disposed at the first corner A of the carrier 33, and a second magnetic member 352 disposed at the second corner B. The support assembly 35 further comprises a first guide member 353 and a second guide member 354 disposed on the base 32 and extending along the optical axis direction. The first guide member 353 is opposite to the first magnetic member 351, and the second guide member 354 is opposite to the second magnetic member 352. The magnetic force between the first magnetic member 351 and the first guide member 353 and the magnetic force between the second guide member 354 and the second magnetic member 352 are used to support the carrier 33 on the first guide member 353 and the second guide member 354. The carrier 33 and the base 32 clamp the first guide member 353 and the second guide member 354. The first guide member 353 and/or the second guide member 354 are used to limit and guide the displacement of the carrier 33, so as to ensure that the carrier 33 moves along the direction defined by the first guide member 353 and/or the second guide member 354. It is worth mentioning that usually only the first guide member 353 or the second guide member 354 is used to guide and limit the carrier 33. If the first guide member 353 and the second guide member 354 guide and limit the carrier 33 at the same time, the requirements for component accuracy will increase, and the production cost will increase. When the carrier 33 is acted upon by the driving assembly 34, the force of the driving assembly 34 overcomes the friction between the first guide member 353, the second guide member 354 and the carrier 33, and drives the carrier 33 to move up and down along the first guide member 353 and/or the second guide member 354.

Furthermore, there are at least two contact positions 3533 and 3534 spaced apart between the first guide member 353 and the carrier 33, and there is at least one contact position 3542 between the second guide member 354 and the carrier 33, that is, the first guide member 353 and the second guide member 354 form a stable support for the carrier 33 at least three non-collinear positions.

In some embodiments, as shown in FIG. 2B, the carrier 33 has a first contact surface 41 and a second contact surface 42 that are not coplanar at the first corner A, the first guide member 353 contacts the first contact surface 41 and the second contact surface 42, the carrier 33 has a third contact surface 43 at the second corner B, and the second guide member 354 contacts the third contact surface 43. Preferably, the first guide member 353 and the carrier 33 only contact at the first contact surface 41 and the second contact surface 42, and the second guide member 354 and the carrier 33 only contact at the third contact surface 43. At this time, the first guide member 353 mainly plays a role in limiting and guiding the carrier 33, and the second guide member 354 mainly plays a role in supporting.

The central axis of the first guide member 353 along the optical axis direction and the central axis of the second guide member 354 along the optical axis direction define a support surface 355, or in other words, the central axis of the first guide member 353 along the optical axis direction and the central axis of the second guide member 354 along the optical axis direction are parallel to each other and are located together in the support surface 355. It can be understood that the support surface mentioned in the present application is a virtual surface.

As shown in FIG. 2B, the third contact surface 43 is parallel to the support surface 355, the angle between the first contact surface 41 and the support surface 355 is θ1, the angle between the second contact surface 42 and the support surface 355 is θ2, θ1≠90°, θ 2 ≠90°. Preferably, θ1=θ 2. It should be understood that at the second corner B, since the third contact surface 43 is parallel to the support surface 355, the second guide member 354 does not limit and guide the carrier 33, and therefore, the first guide member 353 at the first corner A is mainly used to guide the carrier 33, which is conducive to reducing the requirements for component accuracy.

In some embodiments, there are two contact positions 3533a and 3533b between the first guide member 353 and the first contact surface 41 spaced apart along the optical axis direction, there are two contact positions 3534a and 3534b between the first guide member 353 and the second contact surface 42 spaced apart along the optical axis direction, and there is one contact position between the second guide member 354 and the third contact surface 43. That is, the support of the carrier 33 by the first guide member 353 and the second guide member 354 forms a relatively stable triangle, ensuring the support stability.

In some embodiments, the surface 3511 of the first magnetic member 351 facing the first guide member 353 and the surface 3521 of the second magnetic member 352 facing the second guide member 354 are parallel to the support surface 355, so that the first magnetic attraction force and the second magnetic attraction force are perpendicular to the support surface 355, further reducing the risk of the carrier 33 rotating with respect to the base 32. The surface 3521 of the second magnetic member 352 facing the second guide member 354 is parallel to the third contact surface 43, and the angle between the surface 3511 of the first magnetic member 351 facing the first guide member 353 and the first contact surface 41, the angle between the surface 3511 of the first magnetic member 351 facing the first guide member 353 and the second contact surface 42 are both acute angles.

In some embodiments, the first guide member 353 and the second guide member 354 are respectively implemented as guide rods, and the first guide member 353 and the second guide member 354 are fixed to the base 32, so that the carrier 33 moves along the guiding direction of the first guide member 353 and/or the second guide member 354.

In some embodiments, the first magnetic member 351 and the second magnetic member 352 may be implemented as magnets, and the first guide member 353 and the second guide member 354 may be implemented as iron-containing materials suitable for being attracted by magnets. The material of the guide member may be set according to specific circumstances, and this application does not limit this.

In other embodiments, yoke elements are respectively arranged on the side of the first guide member 353 and the second guide member 354 opposite to the first magnetic member 351 and the second magnetic member 352, and the carrier 33 is supported by the magnetic attraction between the yoke elements on the guide members and the magnetic members.

As shown in FIG. 3, the driving assembly 34 comprises a first driving part 341 and a second driving part 342 disposed on opposite sides of the carrier 33. The first driving part 341 and the second driving part 342 apply forces to the carrier 33 from opposite sides of the carrier 33 to drive the carrier 33 to move.

As shown in FIG. 4, the carrier 33 comprises a first side surface 331 and a second side surface 332 located on two sides of the first corner A, and a third side surface 333 and a fourth side surface 334 located on two sides of the second corner B. The first side surface 331 is adjacent to the fourth side surface 334, and the second side surface 332 is adjacent to the third side surface 333. The first driving part 341 is arranged on the first side surface 331, and the second driving part 342 is arranged on the third side surface 333. The first side surface 331 and the third side surface 333 are parallel to the second direction, the second side surface 332 and the fourth side surface 334 are parallel to the first direction, the first direction and the second direction are perpendicular to each other and are perpendicular to the optical axis direction. Along the second direction, the first driving part 341 and the second driving part 342 are staggered. Since the support assembly 35 has been arranged at the two corners of the carrier 33, the present application arranges the first driving part 341 and the second driving part 342 close to the other two corners respectively, so that the first driving part 341 and the second driving part 342 are staggered with each other, thereby making full use of the space on the side of the carrier 33, which is conducive to the miniaturization of the driving arrangement 3.

In the prior art, in order to ensure that the first driving part 341 and the second driving part 342 can stably drive the carrier 33 to move, the first driving part 341 and the second driving part 342 are usually symmetrically arranged on two sides of the carrier 33, and the center line of the first driving part 341 and the second driving part 342 passes through the optical axis. However, in the present application, if the first driving part 341 and the second driving part 342 are arranged according to the conventional design, it is necessary to either reduce the size of the first driving part 341 and the second driving part 342 along the second direction, or increase the size of the carrier 33 along the second direction to ensure the symmetry of the first driving part 341 and the second driving part 342. However, reducing the size of the first driving part 341 and the second driving part 342 will affect the size of the driving force, while increasing the size of the carrier 33 is contrary to the pursuit of miniaturization. Based on this, the present application proposes to displace the first driving part 341 and the second driving part 342, and make full use of the space of the carrier 33 without reducing the size of the drive unit and increasing the size of the carrier 33, and reasonably arrange the first driving part 341 and the second driving part 342.

In some embodiments, the driving assembly 34 is a voice coil motor, and the first driving part 341 comprises a first magnet 3411 and a first coil 3412 that are arranged opposite to each other, the first magnet 3411 is arranged in one of the carrier 33 and the base 32, and the first coil 3412 is arranged in the other of the carrier 33 and the base 32; the second driving part 342 comprises a second magnet 3421 and a second coil 3422 that are arranged opposite to each other, the second magnet 3421 is arranged in one of the carrier 33 and the base 32, and the second coil 3422 is arranged in the other of the carrier 33 and the base 32. The first coil 3412 and the first magnet 3411 are arranged opposite to each other in a direction perpendicular to the optical axis direction, and the second coil 3422 and the second magnet 3421 are also arranged opposite to each other in a direction perpendicular to the optical axis direction. The first magnet 3411 and the second magnet 3421 are fixed to two opposite sides of the carrier 33, and the first coil 3412 and the second coil 3422 are fixed to two opposite sides of the base 32, so that after the first coil 3412 and the second coil 3422 are energized, the first magnet 3411, the second magnet 3421 and the carrier 33 are driven to move along the optical axis direction. Preferably, the first magnet 3411 is arranged on the first side surface 331 and adjacent to the fourth side surface 334, and the second magnet 3421 is arranged on the third side surface 333 and adjacent to the second side surface 332, that is, along the second direction, the first magnet 3411 and the second magnet 3421 are staggered.

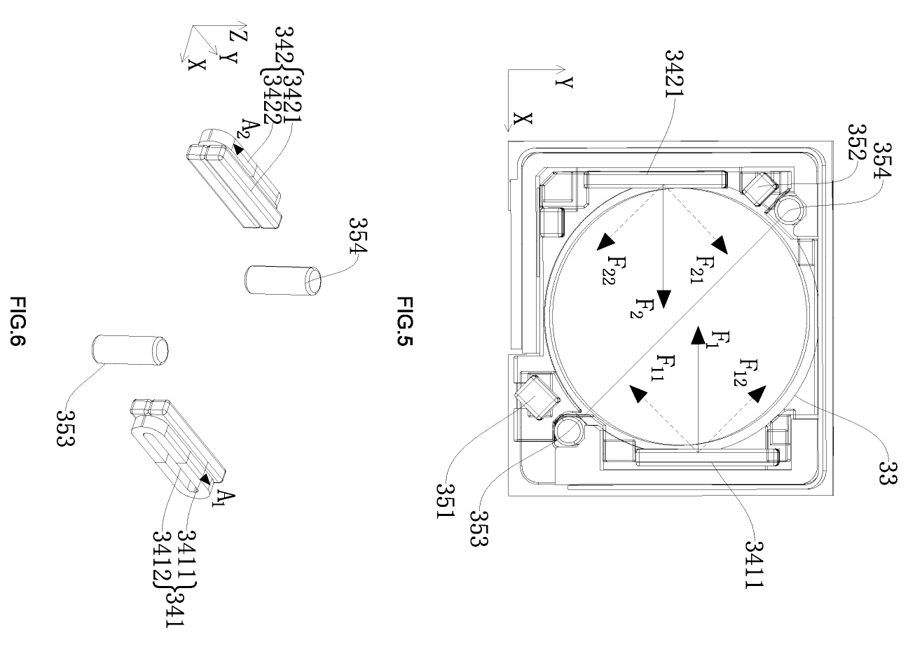

When the first coil 3412 is energized, except for the driving force along the optical axis direction, there will be a first force F1 between the first magnet 3411 and the first coil 3412 along the relative setting direction of the first magnet 3411 and the first coil 3412, and the first force F1 may be a magnetic attraction force or a magnetic repulsion force, which depends on the energizing direction of the first coil 3412. Similarly, when the second coil 3422 is energized, except for the driving force along the optical axis direction, there will be a second force F2 between the second magnet 3421 and the second coil 3422 along the relative setting direction of the second magnet 3421 and the second coil 3422, and the second force F2 may be a magnetic attraction force or a magnetic repulsion force, which depends on the energizing direction of the second coil 3422. It should be understood that the first force F1 and the second force F2 are redundant forces that are not used to drive the carrier 33, which will have an adverse effect on the operation of the driving arrangement 3 and need to be eliminated. When the first force F1 and the second force F2 are in opposite directions, the force components F12 and F22 parallel to the support surface 355 can offset each other, while the force components F11 and F21 perpendicular to the support surface 355 cannot completely offset each other, as shown in FIG. 5, in which the middle diagonal line represents the support surface 355 formed by the central axis of the first guide member 353 along the optical axis direction and the central axis of the second guide member 354 along the optical axis direction. The force component perpendicular to the support surface 355 is conducive to reducing the force required to separate the carrier 33 from the base 32, so the existence of this pair of force components is conducive to reducing the demand for the magnetic attraction of the first magnetic member 351 and the second magnetic member 352, so that the size of the first magnetic member 351 and the second magnetic member 352 can be designed to be smaller, thereby reducing the overall size of the module.

In an embodiment, along the optical axis direction, the magnetic pole distribution of the first magnet 3411 facing the first coil 3412 is the same as the magnetic pole distribution of the second magnet 3421 facing the second coil 3422. When the driving assembly 34 is in operation, when observed in a direction perpendicular to the optical axis direction, the current directions in the first coil 3412 and the second coil 3422 are opposite, so that the directions of the first force F1 and the second force F2 are opposite, and the component forces F12 and F22 parallel to the support surface 355 can offset each other.

As shown in FIG. 6, when viewed along the first direction, the current direction on the upper side of the first coil 3412 is A1, and the current direction on the upper side of the second coil 3422 is A2. The current directions A1 and A2 of the first coil 3412 and the second coil 3422 are opposite. The magnetic pole distribution of the first magnet 3411 facing the first coil 3412 is the same as the magnetic pole distribution of the second magnet 3421 facing the second coil 3422. That is, along the Z-axis direction, the upper magnetic pole of the first magnet 3411 facing the first coil 3412 is N, and the lower magnetic pole is S, and the upper magnetic pole of the second magnet 3421 facing the second coil 3422 is N, and the lower magnetic pole is S; or, the upper magnetic pole of the first magnet 3411 facing the first coil 3412 is S, and the lower magnetic pole is N, and the upper magnetic pole of the second magnet 3421 facing the second coil 3422 is S, and the lower magnetic pole is N. It can be understood that the above arrangement can not only enable the first driving part 341 and the second driving part 342 to generate the same driving force along the optical axis direction, but also enable the first force F1 and the second force F2 to be in opposite directions, thereby at least partially eliminating the redundant forces of the first force F1 and the second force F2 that are not used to drive the carrier 33, thereby improving the operating stability of the driving arrangement 3.

In another embodiment, along the optical axis direction, the magnetic pole distribution of the first magnet 3411 facing the first coil 3412 is opposite to the magnetic pole distribution of the second magnet 3421 facing the second coil 3422. When the driving assembly 34 is in operation, when observed in the direction perpendicular to the optical axis direction, the current directions in the first coil 3412 and the second coil 3422 are the same, so that the directions of the first force F1 and the second force F2 are opposite, and the component forces F12 and F22 parallel to the support surface 355 can offset each other.

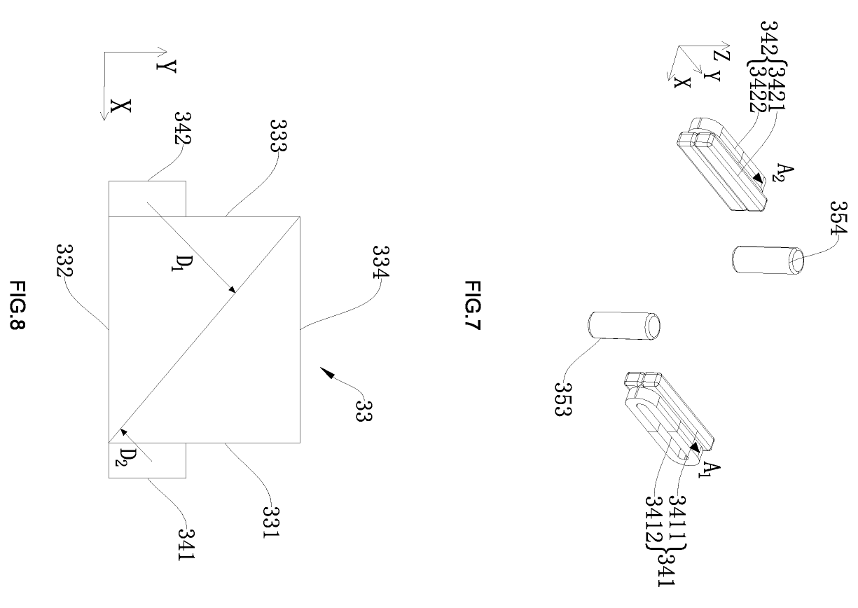

As shown in FIG. 7, when viewed along the first direction, the current directions A1 and A2 of the first coil 3412 and the second coil 3422 are the same; the magnetic pole distribution of the first magnet 3411 facing the first coil 3412 is opposite to the magnetic pole distribution of the second magnet 3421 facing the second coil 3422. Along the Z-axis direction, the upper magnetic pole of the first magnet 3411 facing the first coil 3412 is N, and the lower magnetic pole is S, and the upper magnetic pole of the second magnet 3421 facing the second coil 3422 is S, and the lower magnetic pole is N; or, the upper magnetic pole of the first magnet 3411 facing the first coil 3412 is S, and the lower magnetic pole is N, and the upper magnetic pole of the second magnet 3421 facing the second coil 3422 is N, and the lower magnetic pole is S. The above arrangement can also make the first driving part 341 and the second driving part 342 generate the same driving force along the optical axis direction, and can also make the directions of the first force F1 between the first coil 3412 and the first magnet 3411 and the second force F2 between the second coil 3422 and the second magnet 3421 opposite to each other, thereby eliminating the redundant forces of the first force F1 and the second force F2 that are not used to drive the carrier 33, thereby improving the operating stability of the driving arrangement 3.

It can be understood that since the carrier 33 will be driven upward or downward along the optical axis direction with respect to the base 32 to achieve different focusing requirements, the first coil 3412 and the second coil 3422 will pass a positive current or a reverse current when the same driving direction is required. After the current direction is reversed, the first force F1 and the second force F2 will also reverse. However, as long as the first force F1 and the second force F2 are kept in opposite directions, part of the force will be offset.

Furthermore, in order to offset the effects of the force component F11 and the force component F21 as much as possible, it is necessary to make the force arm lengths of the force component F11 and the force component F21 close to each other. To this end, the present application shifts the first driving part 341 (the first coil 3412 and the first magnet 3411) and the second driving part 342 (the second coil 3422 and the second magnet 3421) disposed on both sides of the driving arrangement 3 to the sides by substantially the same distance, so that the lengths of the two force arms can be relatively close.

In some embodiments, as shown in FIG. 8, the middle diagonal line in the figure represents a support surface 355 formed by connecting the central axis of the first guide member 353 along the optical axis direction and the central axis of the second guide member 354 along the optical axis direction. The support surface 355 has a central axis of the support surface 355 along the optical axis direction, and the vertical distances between the central axis of the support surface 355 and the central axis of the first guide member 353 and the central axis of the second guide member 354 are equal. When the first driving part 341 and the second driving part 342 are both close to the second side surface 332, that is, when the first driving part 341 and the second driving part 342 are respectively located on the same side of the central axis of the support surface 355 along the second direction, the distance D1 from the center of the first magnet 3411 to the support surface 355 and the distance D2 from the center of the second magnet 3421 to the support surface 355 have a significant difference. In this case, it is obvious that there is a large difference in the lengths of the two force arms of the first component force F11 and the second component force F21, and thus the torques of the first component force F11 and the second component force F21 will also have a large difference, so that the part of the influence of the two component forces that is offset is small.

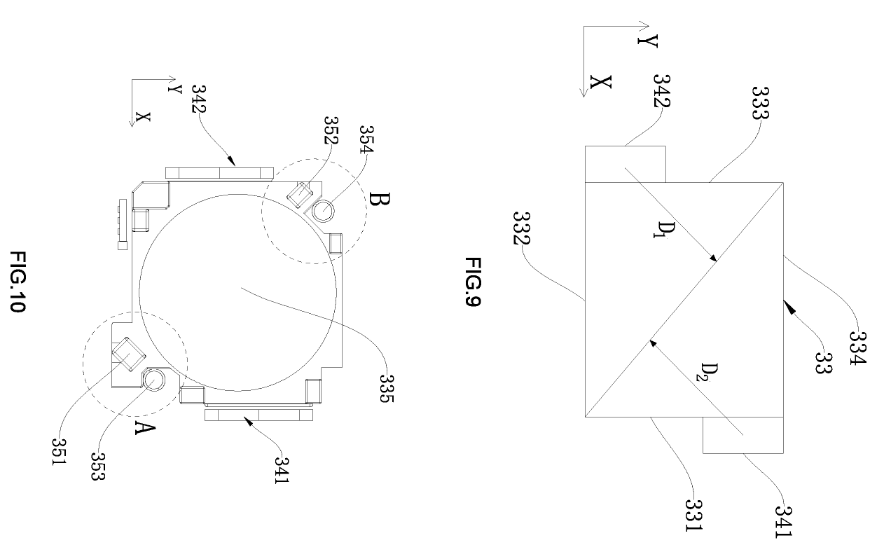

In some embodiments, as shown in FIG. 9, the middle diagonal line in the figure represents a support surface 355 formed by the central axis of the first guide member 353 along the optical axis direction and the central axis of the second guide member 354 along the optical axis direction. The support surface 355 has a central axis of the support surface 355 along the optical axis direction, and the vertical distances between the central axis of the support surface 355 and the central axis of the first guide member 353 and the central axis of the second guide member 354 are equal. When the first driving part 341 is close to the fourth side surface 334, and the second driving part 342 is close to the second side surface 332, that is, the first driving part 341 and the second driving part 342 are respectively located on two sides of the central axis of the support surface 355 along the second direction, it is obvious that the force arms of the first component force F11 and the second component force F21 will be closer or even equal, so that the moments of the first component force F11 and the second component force F21 will be closer or even equal, and then the adverse effects of the two component forces can be better offset. It should be understood that the first driving part 341 and the second driving part 342 are respectively located on two sides of the central axis of the support surface 355 along the second direction, which means that the central part of the first driving part 341 and the central part of the second driving part 342 are respectively located on two sides of the central axis of the support surface 355 along the second direction.

It can be understood that, as shown in FIG. 10, along the Y-axis direction, the present application sets the first driving part 341 at a position away from the first corner A, and sets the second driving part 342 at a position away from the second corner B, which helps to further offset the effects of the first component force F11 and the second component force F21, so as to further optimize the space in the driving arrangement 3, so that the support assembly 35 has more accommodating space in the driving arrangement 3, thereby being able to further compress the size of the driving arrangement 3 along the Y-axis direction.

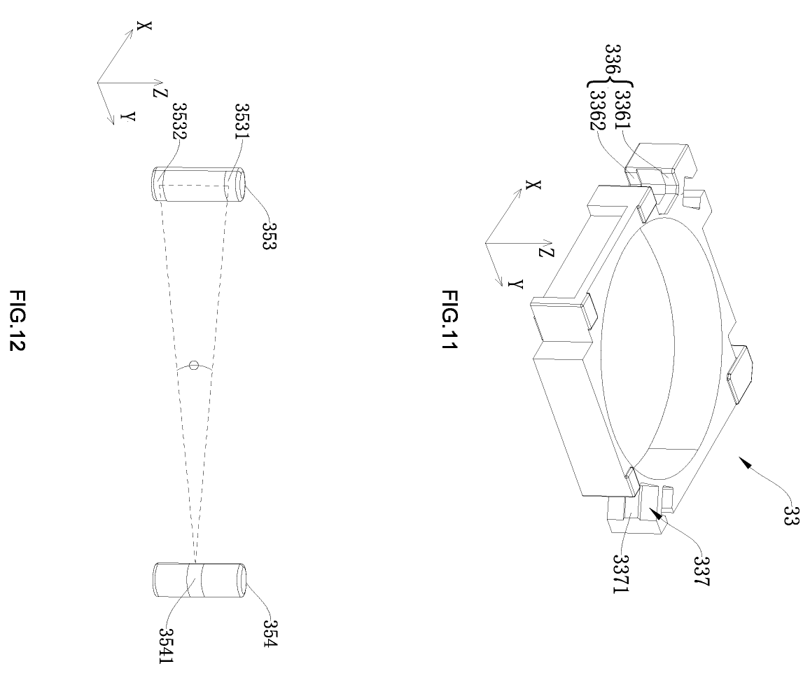

Further, as shown in FIGS. 11, 12 and 13, the carrier 33 has a first guide part 336 extending along the Z-axis direction corresponding to the first guide member 353, and has a second guide part 337 extending along the Z-axis direction corresponding to the second guide member 354. The first guide part 336 has a first protrusion 3361 and a second protrusion 3362, and the first guide member 353 has a first support position 3531 and a second support position 3532 at positions corresponding to the first protrusion 3361 and the second protrusion 3362. The second guide part 337 has a third protrusion 3371, and the second guide member 354 has a third support position 3541 at a position corresponding to the third protrusion 3371. Thus, along the Z-axis direction, the first guide member 353 and the second guide member 354 form a stable triangular support for the carrier 33, and the first guide member 353 and the second guide member 354 can achieve a stable supporting effect on the carrier 33.

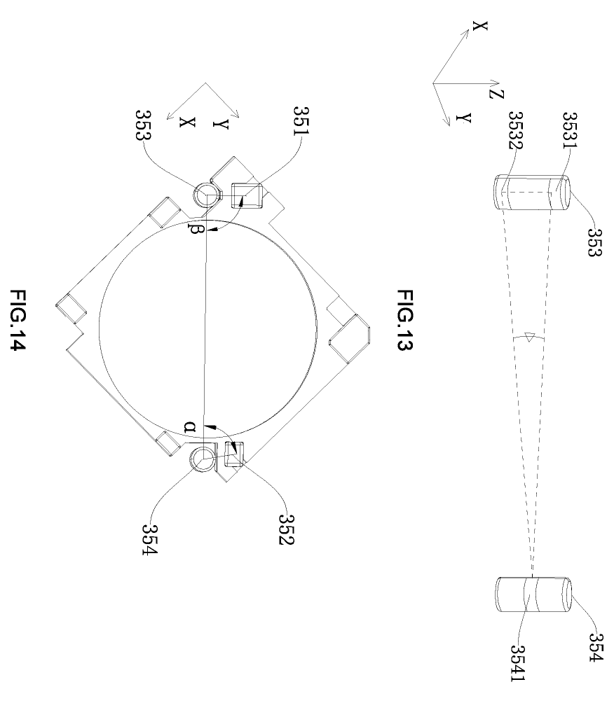

In order to further miniaturize the driving arrangement 3, it is necessary to reduce the height of the driving arrangement 3 along the Z-axis direction, so the heights of the first guide member 353 and the second guide member 354 along the Z-axis direction need to be reduced simultaneously. Since the first magnetic member 351 and the first guide member 353 generate a first magnetic attraction, and the second magnetic member 352 and the second guide member 354 generate a second magnetic attraction, when the first magnetic attraction is equal to the second magnetic attraction, as shown in FIG. 12, the center of the combined force of the first magnetic attraction and the second magnetic attraction, that is, the position marked by the circle in the figure, is exactly in the middle of the first guide member 353 and the second guide member 354. As shown in FIG. 13, when the distance between the first protrusion 3361 and the second protrusion 3362 of the first guide part 336 decreases, the distance between the first support position 3531 and the second support position 3532 on the first guide member 353 is shortened accordingly, which will make the triangle shown by the dotted line in FIG. 12 become a more slender triangle shown in FIG. 13, thereby making the position of the combined magnetic attraction of the first magnetic attraction and the second magnetic attraction closer to the upper and lower sides of the triangle, that is, the support of the carrier 33 on the base 32 will be unstable. Therefore, the present application proposes to offset the position of the combined action of the first magnetic attraction and the second magnetic attraction of the driving arrangement 3 to one side of the first guide member 353, so that the center of the combined force of the first magnetic attraction and the second magnetic attraction (i.e., the position marked by the triangle in FIG. 13) is biased to one side of the first guide member 353, thereby improving the stability of the carrier 33.

Specifically, the size of the first magnetic member 351 is larger than the second magnetic member 352, so that the first magnetic attraction is greater than the second magnetic attraction, so that the combined force of the first and second magnetic attraction is biased toward the first guide member 353 to enhance the support stability of the carrier 33 on the base 32.

In some embodiments, the magnetic attraction force of the first magnetic member 351 is 20mN-25mN, and the magnetic attraction force of the second magnetic member 352 is 10mN-15mN, so as to ensure that the combined force of the first magnetic attraction force and the second magnetic attraction force is biased toward the first guide member 353.

In some embodiments, as shown in FIG. 14, on a plane perpendicular to the optical axis direction, the angle between the line connecting the geometric center of the second guide member 354 and the geometric center of the second magnetic member 352 and the line connecting the geometric center of the second guide member 354 and the geometric center of the first guide member 353 is α, and α≤90°. Preferably, α<90°, that is, the second magnetic member 352 is located on the side of the second guide member 354 close to the first guide member 353, so that the direction of the magnetic attraction force is offset to the side of the first guide member 353, thereby improving the stability of the guide support carrier 33 on the base 32.

In some embodiments, on a plane perpendicular to the optical axis direction, the angle between the geometric center of the first guide member 353 and the geometric center of the first magnetic member 351 and the line connecting the geometric center of the second guide member 354 and the geometric center of the first guide member 353 is β, β≥90°, so that the direction of the magnetic attraction force is offset toward the side of the first guide member 353, thereby improving the stability of the guide member supporting carrier 33 on the base 32.

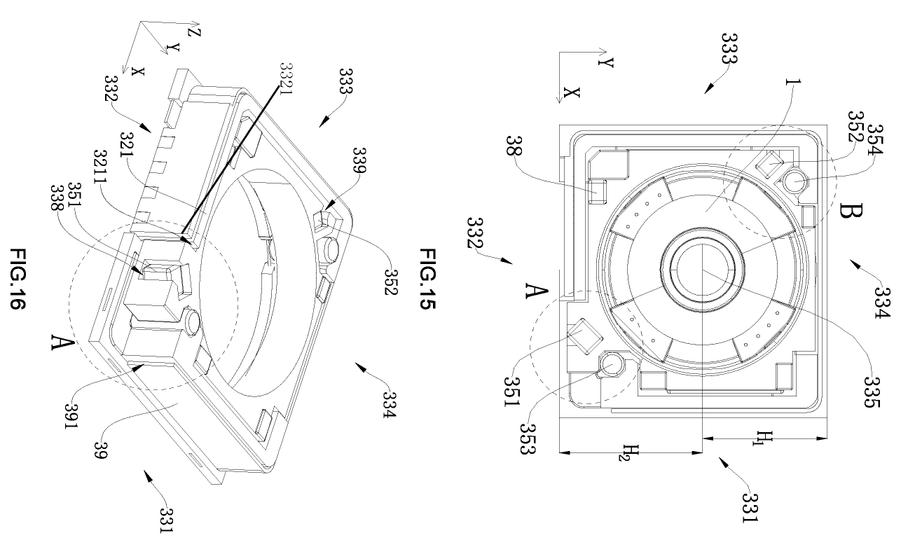

In some embodiments, as shown in FIG. 15, the first magnetic member 351 is located at the first corner A adjacent to the second side surface 332 of the carrier 33. Since the second side surface 332 of the carrier 33 is not provided with a driving part, the first magnetic member 351 with a larger volume is arranged adjacent to the second side surface 332, so that more space can be reserved for the first side surface 331 to arrange the first driving unit 341. The second magnetic member 352 is located at the second corner B adjacent to the third side surface 333 of the carrier 33. Since the volume of the second magnetic member 352 is relatively small, it is arranged adjacent to the third side surface 333. In this way, the wall thickness required for the fourth side surface 334 can be effectively reduced, which is conducive to reducing the overall size. At this time, the fourth side surface 334 of the carrier 33 can reserve more accommodation space, so the carrier 33 can be offset to the position close to the fourth side surface 334, so that the internal space of the driving arrangement 3 is further optimized, the internal component design is more compact, and the overall size of the driving arrangement 3 is further reduced.

As shown in FIG. 15, a vertical distance H1 between a central axis of the optical through-hole 335 of the carrier 33 and the fourth side surface 334 of the carrier 33 is smaller than a vertical distance H2 between the central axis of the optical through-hole 335 and the second side surface 332. Since the driving arrangement 3 of the present application is not provided with a driving magnet or a driving coil near the fourth side surface 334 of the carrier 33, the fourth side surface 334 of the carrier 33 can be designed to be narrower, and thus the central axis of the optical through-hole 335 of the carrier 33 is biased toward the fourth side surface 334, and the optical lens 1 is also offset toward the fourth side surface 334 along with the carrier 33, which can further reduce the overall size of the driving arrangement 3 without affecting the function of the driving arrangement 3.

As shown in FIG. 16, a first avoidance hole 338 is formed at the position where the second side surface 332 of the carrier 33 faces the first magnetic member 351, and a second avoidance hole 339 is formed at the position where the third side surface 333 of the carrier 33 faces the second magnetic member 352, so that the protruding parts of the first magnetic member 351 and the second magnetic member 352 are extended out of the first avoidance hole 338 and the second avoidance hole 339, thereby eliminating the need to increase the size of the carrier 33 along the first direction and the second direction, thereby reducing the size of the overall driving arrangement 3.

Furthermore, as shown in FIG. 16, since the size of the first magnetic member 351 in the present application is larger than that of the second magnetic member 352, the base 32 comprises a side wall 321 arranged around the outside of the carrier 33, and a first avoidance opening 3211 is formed at a position where the side wall 321 of the base 32 is corresponding to the first avoidance hole 338 of the second side surface 332 of the carrier 33. The size of the first avoidance opening 3211 is larger than that of the first avoidance hole 338, so as to fully accommodate the part of the carrier 33 that protrudes out when the size of the first magnetic member 351 increases. A portion of the second side surface 332 of the carrier 33 that is corresponding to the first avoidance opening 3211 protrudes outward to extend into the first avoidance opening 3211, thereby further obtaining a larger space for accommodating the first magnetic member 351 and reducing the size of the overall driving arrangement 3.

Furthermore, as shown in FIG. 16, the base 32 further comprises an electric conductive part 39 which is disposed around the four sides of the base 32, and a second avoidance opening 391 is formed at a position where the electric conductive part 39 is corresponding to the first avoidance opening 3211 of the second side surface 332 of the carrier 33, so that the first magnetic member 351 has a larger accommodating space, further reducing the overall size of the driving arrangement 3.

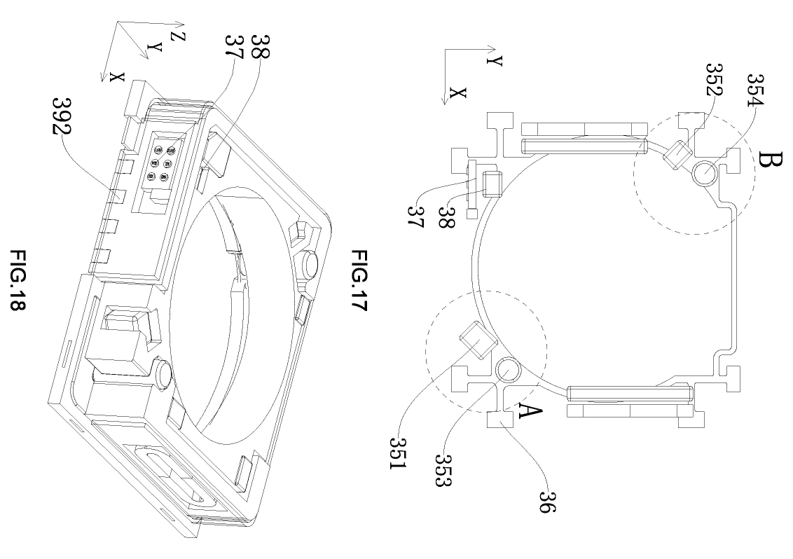

In some embodiments, as shown in FIG. 17, the driving arrangement 3 further comprises a fixing insert 36 which is embedded in the base 32, and the connection portion corresponding to the first guide member 353 and the second guide member 354 is exposed from the base 32. The fixing insert 36 is used to fix the first guide member 353 and the second guide member 354 to ensure that the first guide member 353 and the second guide member 354 remain stable during the optical focusing movement, reduce vibration and jitter, and improve the movement smoothness of the carrier 33.

In some embodiments, the sides of the first guide member 353 and the second guide member 354 are respectively fixed to the side walls 321 of the base 32 by glue, and the bottom surfaces of the first guide member 353 and the second guide member 354 can be fixed to the fixing insert 36 by glue or welding, thereby effectively improving the connection reliability between the base 32 and the guide members and reducing faults caused by loose connections.

In some embodiments, the first guide member 353 and the second guide member 354 may not be fixed, but may be directly disposed between the carrier 33 and the base 32 in a clamping manner, so as to facilitate quick installation and removal of the guide members and improve work efficiency.

Furthermore, as shown in FIG. 18, the driving arrangement 3 further comprises a position sensor 37 and a position sensing magnet 38. The position sensing magnet 38 is fixed to the carrier 33, and the position sensor 37 is fixed to the base 32 and is opposite to the position sensing magnet 38. The position sensor 37 is used to obtain the position change information of the position sensing magnet 38 with respect to the base 32, thereby obtaining the position change information of the carrier 33 with respect to the base 32.

Furthermore, the position sensing magnet 38 is arranged on the side where the first magnet 3411 or the second magnet 3421 is not arranged. It should be understood that the independent arrangement of the position sensing magnet 38 can reduce the requirements for other magnets and related components that may be reused. Using the first magnet 3411 or the second magnet 3421 as the position sensing magnet 38 will require the first magnet 3411 or the second magnet 3421 to reserve a space with respect to the position sensor 37, and will require the first coil 3412 and the second coil 3422 to provide space for the arrangement of the position sensing magnet 38. Therefore, the position sensing magnet 38 is arranged on the side where the first magnet 3411 or the second magnet 3421 is not arranged, which can further reduce the space utilization rate of the driving arrangement 3 along the first direction, and help to reduce the overall size of the driving arrangement 3. Preferably, the position sensing magnet 38 is arranged on the second side surface 332 of the carrier 33. The second side surface 332 of the carrier 33 is suitable for forming a groove to accommodate the position sensing magnet 38, thereby avoiding the increase in the size of the driving arrangement 3.

In some embodiments, the first coil 3412, the second coil 3422, and the position sensor 37 are all electrically connected to the electric conductive part 39, and are electrically connected to the photosensitive assembly 2 through the electric conductive part 39.

In some embodiments, the electric conductive part 39 is implemented as a circuit board fixed to the outer peripheral side of the base 32, and the electric conductive part 39 is arranged around the four outer peripheral sides of the base 32. Specifically, an opening is provided on the base 32 corresponding to the first coil 3412, the second coil 3422 and the position sensor 37, and the first coil 3412, the second coil 3422 and the position sensor 37 are respectively fixed through the opening and electrically connected to the electric conductive part 39, so that the first coil 3412, the second coil 3422 and the position sensor 37 are respectively fixed to the base 32 through the electric conductive part 39.

In some embodiments, the electric conductive part 39 comprises an electrical conduction portion 392 which is used to electrically connect to the photosensitive assembly 2 of the camera module.

In addition, as shown in FIG. 1C, the present application also provides a camera module having the above-mentioned driving arrangement 3, wherein the camera module comprises an optical lens 1, a driving arrangement 3 and a photosensitive assembly 2. The optical lens 1 is held on the photosensitive path of the photosensitive assembly 2 by the driving arrangement 3, and the photosensitive assembly 2 is used to receive the light emitted by the optical lens 1 for imaging to obtain an image of the subject. The driving arrangement 3 is suitable for driving the optical lens 1 to move to achieve optical performance adjustment.

Furthermore, the optical lens 1 has an optical axis, the direction of the optical axis is parallel to the Z axis of the camera module along the height direction, and the photosensitive assembly 2 is arranged opposite to the optical lens 1 along the optical axis direction.

In some embodiments, the optical lens 1 comprises a lens barrel 11 and at least one optical lens 12 installed in the lens barrel 11, and the at least one optical lens 12 is arranged in the lens barrel 11 along the optical axis. The optical lens 1 is installed on the carrier 33 of the driving arrangement 3 through the lens barrel 11.

In some embodiments, the lens barrel 11 and the carrier 33 of the optical lens 1 are integrally formed, which is equivalent to at least one lens being directly installed in the carrier 33 having the function of the lens barrel 11, which can further reduce the lateral dimensions of the driving arrangement 3 in the width and length directions.

Furthermore, the photosensitive assembly 2 comprises an imaging circuit board 24, a photosensitive chip 21 electrically connected to the imaging circuit board 24, and at least one electronic component 25. The photosensitive chip 21 is used to receive the light reflected by the object collected by the optical lens 1 for imaging and is electrically connected to other electronic devices through the imaging circuit board 24. The electronic component 25 can be one or more of passive electronic devices such as resistors and capacitors, or one or more of active electronic devices such as drive chips and storage chips.

In some embodiments, the photosensitive assembly 2 comprises a optical filter element 22, which is held on the photosensitive path of the photosensitive chip 21, so as to filter the imaging light incident on the photosensitive chip 21, and filter out the light that is not necessary for imaging, such as infrared light, in the incident light. Further, the photosensitive assembly 2 further comprises a bracket 23, and the optical filter element 22 is mounted on the bracket 23, and the bracket 23 is fixed to the imaging circuit board 24, so that the optical filter element 22 is fixed to the imaging circuit board 24 through the bracket 23.

In some embodiments, the driving arrangement 3 is fixed on the photosensitive assembly 2 by being fixed to the bracket 23. The stress is transmitted by the bracket 23, so that the photosensitive assembly 2 can avoid being directly subjected to the impact force of the driving arrangement 3. In other embodiments, the driving arrangement 3 can also be fixed to the photosensitive assembly 2 by being fixed to the imaging circuit board 24. In this case, the bracket 23 is retracted with respect to the edge of the imaging circuit board 24 to provide a fixed position for the driving arrangement 3, so as to reduce the space occupied by the bracket 23, and make the entire device more compact.

The above describes the basic principles, main features and advantages of the present application. Those skilled in the art should understand that the present application is not limited to the above embodiments. The above embodiments and the specification only describe the principles of the present application. The present application may have various changes and improvements without departing from the spirit and scope of the present application. These changes and improvements fall within the scope of the present application for which protection is sought.

What is claimed is:

1. A driving arrangement, comprising:
a base;
a support assembly;
a carrier, wherein the carrier has an optical through-hole penetrating along an optical axis direction, the carrier has a first corner and a second corner at a diagonal position, and the carrier is supported on the base by the support assembly at the first corner and the second corner; and
a driving assembly arranged for driving the carrier to move along the optical axis direction with respect to the base, the driving assembly comprises a first driving part and a second driving part arranged on opposite sides of the carrier, wherein the first driving part comprises a first magnet and a first coil arranged oppositely, the first magnet is arranged on one of the carrier and the base, and the first coil is arranged on the other of the carrier and the base; wherein the second driving part comprises a second magnet and a second coil arranged oppositely, the second magnet is arranged on one of the carrier and the base, and the second coil is arranged on the other of the carrier and the base;
wherein along the optical axis direction, a magnetic pole distribution of the first magnet facing the first coil is the same as a magnetic pole distribution of the second magnet facing the second coil, and when the driving assembly is in operation, current directions in the first coil and the second coil are opposite when observed along a direction perpendicular to the optical axis direction;
or,
wherein along the optical axis direction, the magnetic pole distribution of the first magnet facing the first coil is opposite to the magnetic pole distribution of the second magnet facing the second coil, when the driving assembly is in operation, the current directions in the first coil and the second coil are the same when observed in the direction perpendicular to the optical axis direction.

2. The driving arrangement, as recited in claim 1, wherein the carrier further comprises a first side surface and a second side surface located on two sides of the first corner, and a third side surface and a fourth side surface located on two sides of the second corner, the first side surface is adjacent to the fourth side surface, the second side surface is adjacent to the third side surface, the first driving part is arranged on the first side surface, the second driving part is arranged on the third side surface, the first side surface and the third side surface are parallel to a second direction, the second side surface and the fourth side surface are parallel to a first direction, the first direction and the second direction are perpendicular to each other and are both perpendicular to the optical axis direction, and along the second direction, the first driving part and the second driving part are staggered.

3. The driving arrangement, as recited in claim 2, wherein the support assembly comprises a first guide member and a second guide member which are arranged on the base and extended along the optical axis direction, the first guide member is located at the first corner, the second guide member is located at the second corner, a central axis of the first guide member along the optical axis direction and a central axis of the second guide member along the optical axis direction define a support surface, the support surface has a central axis along the optical axis direction, the central axis of the support surface is at an equal vertical distance from the first guide member and the second guide member, and the first driving part and the second driving part are respectively located on two sides of the central axis of the support surface along the second direction.

4. The driving arrangement, as recited in claim 3, wherein the support assembly further comprises a first magnetic member arranged at the first corner and a second magnetic member arranged at the second corner, the first guide member is arranged opposite to the first magnetic member, and the second guide member is arranged opposite to the second magnetic member.

5. The driving arrangement, as recited in claim 4, wherein at least two contact positions between the first guide member and the carrier are arranged at intervals along the optical axis direction, at least one contact position is arranged between the second guide member and the carrier, a first magnetic attraction force is generated between the first magnetic member and the first guide member, a second magnetic attraction force is generated between the second magnetic member and the second guide member, and a size of the first magnetic member is larger than a size of the second magnetic member, so as to allow the first magnetic attraction force to be greater than the second magnetic attraction force.

6. The driving arrangement, as recited in claim 4, wherein on a plane perpendicular to the optical axis, an angle between a line connecting geometric centers of the second guide member and the second magnetic member and a line connecting geometric centers of the second guide member and the first guide member is α, and α≤90°.

7. The driving arrangement, as recited in claim 4, wherein the first magnetic member is disposed adjacent to the second side surface of the carrier, and the second magnetic member is disposed adjacent to the third side surface of the carrier.

8. The driving arrangement, as recited in claim 7, wherein a first avoidance hole is formed at a position where the second side surface of the carrier faces the first magnetic member, and a second avoidance hole is formed at a position where the third side surface of the carrier faces the second magnetic member, the base comprises a side wall arranged around an outer side of the carrier, and a first avoidance opening is formed at a position where the side wall of the base is corresponding to the first avoidance hole on the second side surface of the carrier, a size of the first avoidance opening is larger than a size of the first avoidance hole, and a portion of the second side surface of the carrier corresponding to the first avoidance opening protrudes outward to extend into the first avoidance opening.

9. The driving arrangement, as recited in claim 8, wherein the base further comprises an electric conductive part which is arranged around the side wall of the base, and a second avoidance opening is formed at a position where the electric conductive part is corresponding to the first avoidance opening.

10. The driving arrangement, as recited in claim 7, wherein the first magnetic member is arranged on the first side surface of the carrier, the second magnetic member is arranged on the third side surface of the carrier, a position sensing magnet is arranged on the second side surface of the carrier, a position sensor is arranged on the base opposite to the position sensing magnet, and a vertical distance between the center axis of the optical through-hole and the fourth side surface is smaller than a vertical distance between the center axis of the optical through-hole and the second side surface.

11. The driving arrangement, as recited in claim 4, wherein the carrier has a first contact surface and a second contact surface that are not coplanar at the first corner, the first guide member contacts the first contact surface and the second contact surface, the carrier has a third contact surface at the second corner, and the second guide member contacts the third contact surface; the central axis of the first guide member along the optical axis direction and the central axis of the second guide member along the optical axis direction define the support surface, the third contact surface is parallel to the support surface, an angle between the first contact surface and the support surface is θ1, an angle between the second contact surface and the support surface is θ2, θ1≠90°, θ2≠90°.

12. The driving arrangement, as recited in claim 11, wherein the first guide member contacts the carrier only at the first contact surface and the second contact surface, two contact positions are provided between the first guide member and the first contact surface and are spaced apart along the optical axis direction, two contact positions are provided between the first guide member and the second contact surface and are spaced apart along the optical axis direction, the second guide member contacts the carrier only at the third contact surface, and one contact position is provided between the second guide member and the third contact surface, wherein θ1=θ2.

13. The driving arrangement, as recited in claim 11, wherein a surface of the second magnetic member facing the second guide member is parallel to the third contact surface; and an angle between a surface of the first magnetic member facing the first guide member and the first contact surface and an angle between the surface of the first magnetic member facing the first guide member and the second contact surface are all acute angles.

14. The driving arrangement, as recited in claim 11, wherein a surface of the first magnetic member facing the first guiding member and a surface of the second magnetic member facing the second guiding member are respectively parallel to the support surface.
